(19) United States
(12) Patent Application Publication
(10) Pub. No.: US 2016/0188586 A1
(43) Pub. Date: Jun. 30, 2016

(54) Method and Apparatus for Monitoring the Performance of Personal Protective Equipment to Identify Trends and Failures in Repairs

(71) Applicant: HONEYWELL INTERNATIONAL INC., Morristown, NJ (US)

(72) Inventors: Marcus GRAMS, Middletown, OH (US); Jennifer Brust, Bellbrook, OH (US); Brian Marenco, Coatesville, PA (US)

(21) Appl. No.: 14/588,233

(22) Filed: Dec. 31, 2014

(51) Int. Cl. G06F 17/30; G06F 3/0482; G06F 3/0484

(52) U.S. Cl. CPC G06F 17/3028; G06F 17/30265; G06F 17/30274; G06F 3/04842; G06F 3/0482

(57) ABSTRACT

A method is provided for monitoring performance of personal protective equipment to identify trends in failures and repairs, and includes the steps of: (a) storing a plurality of images (31), each image (31) being a visual representation of a corresponding configuration (52) of personal protective equipment; (b) creating a database (16) of the specific repairs (58) and the locations (33) of the repairs (58) on each of the configurations (52); and (c) generating individual visual displays (36) of each of said images (31), with each individual visual display (36) illustrating the concentrations (38) of repairs for one of said specific repairs (58) at the identified locations (33) on the image (31).

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### FIELD

This invention relates to personal protective equipment and the need to monitor repairs and failure of personal protective equipment (“PPE”) and to identify trends with respect to the failure and/or repair of the PPE.

### BACKGROUND

Increasingly, fire departments and other first responders are either being required or requiring themselves to document the repair details of personal protective equipment. There is a desire to analyze and identify trends with respect to the repairs and failures, often in relation to manufacturer, configuration/specification, material performance, firefighter usage, and environmental variables. The amount of data to be analyzed can easily span a 10-year wear life of some PPE, such as personal protective garments, and can include hundreds or thousands of specific individual PPE units of a specific type/configuration.

### SUMMARY

In accordance with one feature of this disclosure, a method of monitoring performance of personal protective equipment is provided to identify trends in failures and repairs. The method includes the steps of: (a) storing in a memory device a plurality of images, each image being a visual representation of a corresponding configuration of personal protective equipment, (b) operating an electronic processing system associated with the memory device to selectively access each of said images to identify locations on each of said images where specific repairs have been made on the corresponding configuration of personal protective equipment to create a database of each of the specific repairs and the locations of each of the specific repairs on each of the configurations of personal protective equipment, and (c) operating the electronic processing system to access the database to determine a concentration of each of the specific repairs at each of the locations and to selectively generate individual visual displays of each of said images, each individual visual display illustrating the concentrations of the locations of repairs for one of the specific repairs at the identified locations on the image.

As one feature, step (b) includes generating a visual display of each of the images, utilizing a user input device to indicate the location of each of the specific repairs on each of the displayed images, and automatically storing the locations in the database for each of the specific repairs.

In one feature, step (b) further includes operating the electronic processing system to generate a user input display that allows a user to select which of said images to display.

According to one feature, step (b) further includes operating the electronic processing system to generate a user input display that allows a user to select each of the specific repairs to input into the database for the displayed image.

As one feature, step (b) further includes utilizing a user input device to store additional information associated with each of the specific repairs in the database and operating the electronic processing system to correlate the additional information with each of the specific repairs and each of the images.

In one feature, step (c) further includes operating the electronic processing system to generate a user input display that allows a user to select which of the additional information to display in connection with each of the individual displays.

According to one feature, step (c) further includes operating the electronic processing system to generate a user input display that allows a user to select which of said images to display.

As one feature step (c) further includes operating the electronic processing system to generate a user input display that allows a user to select which of the specific repairs to display for the selected image.

In one feature, step (b) further includes utilizing a user input device to store additional information associated with each of the specific repairs in the database and operating the electronic processing system to correlate the additional information with each of the specific repairs and each of the images.

According to one feature, step (c) further includes operating the electronic processing system to generate a user input display that allows a user to select which of the additional information to display in connection with each of the individual displays.

As one feature, step (c) further includes operating the electronic processing system to generate a gradient scale in each of the individual visual displays to provide numerical values associated with the illustrated concentrations of repairs in each of the individual visual displays.

In one feature, step (c) includes correlating colors to the number of each specific repair at each of the locations and displaying the colors in each individual display to illustrate the concentrations of repairs.

According to one feature, step (c) further includes operating the electronic processing system to generate an a color gradient scale in each of the individual visual displays to provide numerical values associated with each of the colors for the illustrated concentrations of repairs in each of the individual visual displays.

Other features and advantages will become apparent from a review of the entire specification, including the appended claims and drawings.

### BRIEF DESCRIPTION OF THE DRAWINGS

FIG. 1 is a diagrammatic representation of an electronic processing system according to this disclosure;

FIG. 2 is a diagrammatic representation of a method according to this disclosure;

FIG. 3 is a representation of a user display of an electronic processing device, such as the display of a personal computer, and illustrates a data entry screen for entering data into a database of the electronic processing system; and

FIG. 4 is a view similar to FIG. 1 but showing a screen illustrating the concentration and locations of a specific type of repair on a specific configuration of personal protective equipment.

### DETAILED DESCRIPTION

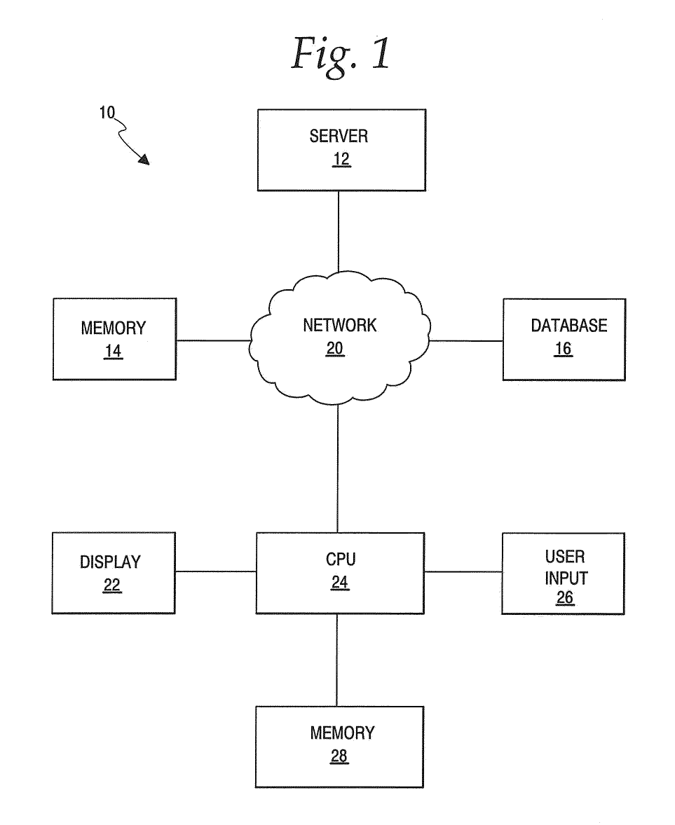

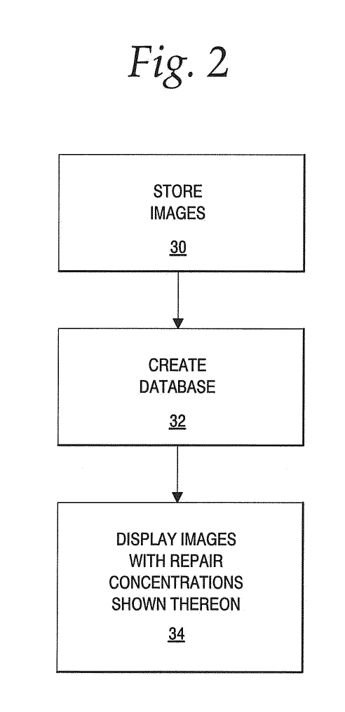

With reference to FIGS. 1 and 2, the method and apparatus disclosed herein are directed to utilizing an electronic processing system 10 to compile a database 16 of the actual repairs made to a variety of personal protective equipment (“PPE”), with the database 16 including the location of each type of repair on each type/configuration of PPE and then presenting that data in a visual display that allows a user to quickly identify trends in the repair and performance of each type/configuration of PPE. To this end, the method and apparatus disclosed herein allows a user to input the location of each repair by presenting a visual display of an image representing each particular type/configuration of PPE and allowing the user to indicate the location on the image where the actual repair was made to the particular type/configuration of PPE, and then, after the data has been entered, to utilize the electronic processing system 10 to generate a visual display that shows the location and concentration of repairs on the image of each particular type/configuration of PPE via a so-called “heat map”, which is a graphical representation of data using colors (or other indicia) to indicate the levels of activity or concentration, with darker colors usually being used to indicate low activity or concentration and brighter colors usually being used to indicate high activity or concentration.

It should be understood that as used here the term “configuration of PPE” is intended to mean any particular type of PPE (for example, any type of protective glove, garment, boot, head gear, fall protection equipment, garments, etc.), or any particular model of a particular type of PPE, or any particular configuration of any particular model of any particular type of PPE.

The method and apparatus disclosed herein also allows for a user to enter other information into the database 16, such as, for example, the manufacturer of each particular configuration of PPE, the amount of usage (hours) of the particular configuration of PPE that resulted in a failure or repair, the environmental variables that resulted in a failure or repair, the particular Fire Department, Battalion, and/or Station where the specific configuration of PPE was utilized, the firefighter or other emergency responder to which the particular configuration of PPE is assigned, the cost of each repair, and any other information that may be useful in identifying trends in the performance, failure, and repair of each particular type/configuration of PPE.

With reference to FIG. 1, the disclosed method and apparatus utilizes an electronic processing system 10 that can include one or more servers 12, one or more memory devices 14, one or more databases 16, and one or more computing devices 18 (such as a personal computer), all connected via a network 20 (such as, for example, a cloud, a local area network, a wide area network, an enterprise private network, a virtual private network, a personal area network, etc.), with each of the computing devices 18 including one or more visual displays 22, one or more CPU's (control processing unit) 24, one or more user input devices 26 (such as, for example, a user keypad, a mouse, a touch pad, a touch screen, etc.), and one or more local memory devices 28. As used herein, it should be understood that the term electronic processing system can include any combination of the above, including, for example, any individual computer device 18.

With reference to FIG. 2, a method is shown for monitoring performance of personal protective equipment to identify trends in failures and repairs. With reference to FIGS. 1-4, the method includes a step 30 of storing in a memory device 14 a plurality of images 31, with each image 31 being a visual representation of a corresponding specific configuration of PPE, a step 32 of operating an electronic processing system 10 associated with the memory device 14 to selectively access each of the images 31 to identify locations 33 on each of the images 31 of specific repairs made on the corresponding configuration of PPE to create a database 16 of each of the specific repairs and the locations 33 of each of the specific repairs on each of the specific configurations of PPE, and a step 34 of operating the electronic processing system 10 to access the database 16 to determine a concentration of each of the specific repairs at each of the locations and to selectively generate individual visual displays 36 of each of the images 31, with each individual visual display 36 illustrating the concentrations 38 of repairs for one of the specific repairs at the identified locations 33 on the image 31.

It should be understood that as used herein, the term “image” is intended to mean an accurate visual representation of a particular configuration of PPE sufficient to allow a viewer to recognize the particular configuration of PPE and to distinguish various locations on the particular configuration of PPE based on the visual representation.

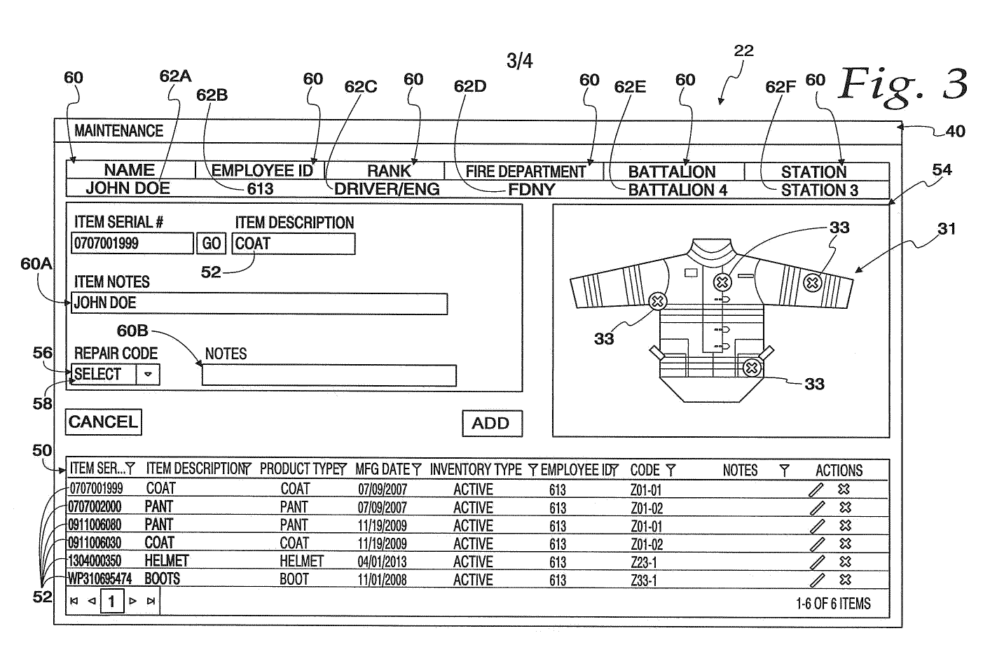

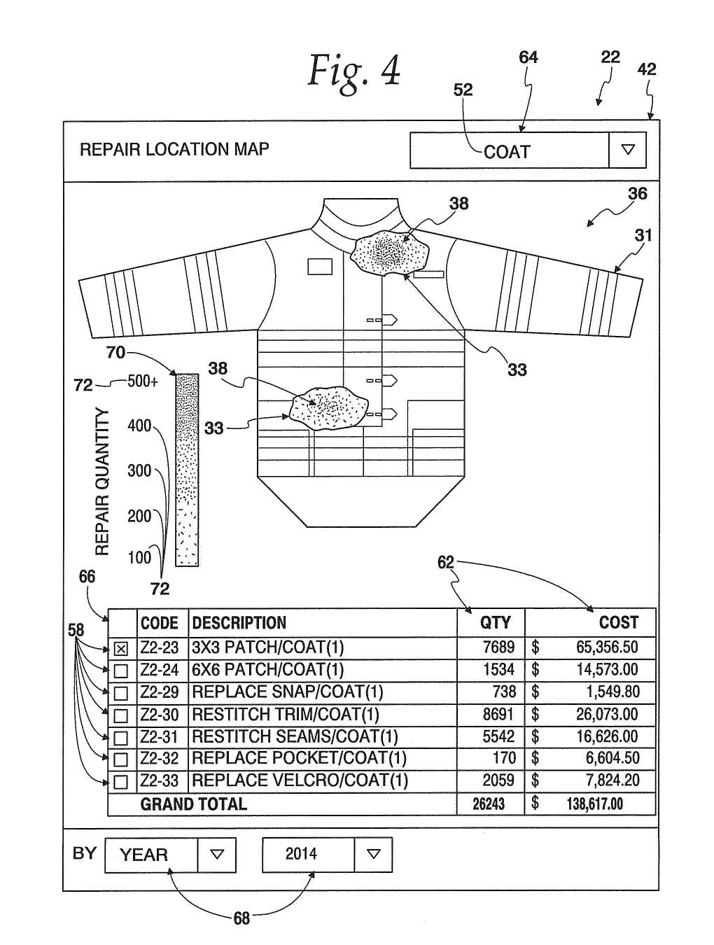

Step 32 can best be understood by reference to FIG. 3 which shows an input screen 40 on a display 22 of the electronic processing system 10 that allows a user to input information connected with each of the images 31, one of which is shown in FIG. 3, including the locations 33 of the specific repairs made to the corresponding configuration of PPE. Step 34 can best be understood by reference to FIG. 4, which illustrates an analysis screen 42 on the display 22 of the processing system 10, and shows a visual display 36 of one of the images 31 with the concentrations 38 and associated locations 33 illustrated on the image 31. In this regard, it should be understood that, for purposes of illustration, FIG. 4 shows the concentrations 38 in the form of greater or lesser concentrations of dots, however these greater or lesser concentration of dots are intended to represent a gradient of colors, with higher concentrations of dots representing the brighter end of the color spectrum at 46 and lower concentrations of dots representing the darker end of the color spectrum at 48. It should be understood that other colors can be associated with higher and lower concentrations, and that in some embodiments, indicia other than color may be used.

As shown in FIG. 3, in some desired embodiments, step 32 includes generating a visual display 40 of each of the images 31, utilizing a user input device 26, such as a mouse or touch pad, to indicate the location 33 of each of the specific repairs on each of the displayed images 31, and automatically storing the indicated locations 33 in the database 16. This can best be understood by reference to FIG. 3, which shows the visual display 40 having one of the images 31 shown therein with a number of locations 33 for a specific type of repair indicated thereon by a display cursor driven by a user operated mouse or touch pad 26.

It also is desirable in some embodiments for step 32 of the method to include operating the electronic processing system 10 to generate a user input display 40 that allows a user to select which of the images 31 to display. This is again best understood by reference to FIG. 3, which shows a menu 50 on the visual display 40 that allows a user to select from a number of specific configurations 52 of PPE, each of which will have a specific image 31 associated therewith that will then be shown in zone 54 of the display 40.

It also can be desirable in some embodiments for step 32 to include operating the electronic processing system 10 to generate a user input display 40 that allows a user to select one of the specific repairs to input into the database 16 for the displayed image 31. This is again best understood with reference to FIG. 3 which shows a drop down menu 56 that allows a user to select a particular repair or repair code 58 to input into the database 16 and to associate with each of the selected locations 33.

It also can be desired for step 32 to include utilizing a user input device 26 to store additional information associated with each of the specific repairs into the database 16 and operating the electronic processing system 10 to correlate the additional information with each of the specific repairs on each of the images 31. This is again best understood with reference to FIG. 3 which shows a number of fields 60 for entering additional information 62, which in the illustrated embodiment includes the name 62A of the user of the particular piece of PPE, the employee ID 62B of the user, the rank 62C of the user, the Fire Department 62D of the user, the Battalion 62E of the user, the Station 62F of the user, the serial number 62G of the particular piece of PPE assigned to the user, and two fields 60A and 60B for entering additional notes and information with respect to the particular repair being entered via the display, with the entry of each of the additional items of information 62 being correlated by the processing system 10 with the specific repair 58, the specific configuration 52 of PPE, and the identified locations 33.

It can also be desirable in some embodiments for step 34 to include operating the electronic processing system 10 to generate a user input display 42 that allows a user to select which of the additional information 62 to display in connection with each of the individual displays 42. It can further be desirable in some embodiments for the step 34 to include operating the electronic processing system 10 to generate a user input display 42 that allows a user to select which of the images 31 to display. It can further be desirable in some embodiments for step 34 to include operating the electronic processing system 10 to generate a user input display 42 that allows a user to select which of the specific repairs 58 to display for the selected image 31. This is best understood by reference to FIG. 3 which shows the display 42 having a dropdown menu 64 that allows a user to select which specific configuration 52 of PPE to show in the display 42, and by a menu 66 that allows a user to select which specific repair 58 to show in the display, and by user selected additional information 62 in the form of the quantity associated with each particular repair 58 and the cost associated with each particular repair 58, and further by drop down menus 68 which allow a user to select the particular date, in terms of year, day, month, etc., of the particular repairs 58 for the particular configuration 52 of PPE.

It can also be desirable in some embodiments for step 34 to include operating the electronic processing system 10 to generate a gradient scale 70 in each of the individual visual displays 42 to provide numerical values 72 associated with the illustrated concentrations of repair in each of the individual visual displays. This is best understood by reference to FIG. 4 which shows a gradient scale at 70 with the numerical values associated with the concentrations of repairs. In this regard, step 34 will typically include correlating colors to the number of each specific repair 58 at each of the locations 33 and displaying the colors in each individual display 36 to illustrate the concentrations 38 of the repairs 58. This can best be understood by reference to FIG. 4, which uses dot densities to illustrate different colors so as to the illustrate the concentrations 38 of repairs 58 at each of the locations 33.

It should be understood that while specific embodiments have been described herein, this disclosure contemplates variations on those embodiments that will be apparent to one skilled in the art.

1. A method of monitoring performance of personal protective equipment to identify trends in failures and repairs, the method comprising the steps of:
(a) storing in a memory device a plurality of images, each image being a visual representation of a corresponding configuration of personal protective equipment;
(b) operating an electronic processing system associated with the memory device to selectively access each of said images to identify locations on each of said images where specific repairs have been made on the corresponding configuration of personal protective equipment to create a database of each of the specific repairs and the locations of each of the specific repairs on each of said configurations of personal protective equipment; and
(c) operating the electronic processing system to access said database to determine a concentration of each of the specific repairs at each of the locations and to selectively generate individual visual displays of each of said images, each individual visual display illustrating the concentrations of repairs at the locations for one of said specific repairs on the image.

2. The method of claim 1 wherein step (b) comprises generating a visual display of each of said images, utilizing a user input device to indicate the location of each of the specific repairs on each of the displayed images, and automatically storing the indicated locations in the database for each of the specific repairs.

3. The method of claim 2 wherein step (b) further comprises operating the electronic processing system to generate a user input display that allows a user to select which of said images to display.

4. The method of claim 3 wherein step (b) further comprises operating the electronic processing system to generate a user input display that allows a user to select each of the specific repairs to input into the database for the displayed image.

5. The method of claim 1 wherein step b) further comprises utilizing a user input device to store additional information associated with each of the specific repairs into the database and operating the electronic processing system to correlate the additional information with each of the specific repairs and each of the images.

6. The method of claim 5 wherein step (c) further comprises operating the electronic processing system to generate a user input display that allows a user to select which of the additional information to display in connection with each of the individual displays.

7. The method of claim 1 wherein step (c) further comprises operating the electronic processing system to generate a user input display that allows a user to select which of said images to display.

8. The method of claim 7 wherein step (c) further comprises operating the electronic processing system to generate a user input display that allows a user to select which of said specific repairs to display for the selected image.

9. The method of claim 8 wherein step (b) further comprises utilizing a user input device to store additional information associated with each of the specific repairs in the database and operating the electronic processing system to correlate the additional information with each of the specific repairs and each of the images.

10. The method of claim 9 wherein step (c) further comprises operating the electronic processing system to generate a user input display that allows a user to select which of the additional information to display in connection with each of the individual displays.

11. The method of claim 1 wherein step (c) further comprises operating the electronic processing system to generate a gradient scale in each of the individual visual displays to provide numerical values associated with the illustrated concentrations of repairs in each of the individual visual displays.

12. The method of claim 1 wherein step (c) comprises correlating colors to the number of each specific repair at each of the locations and displaying the colors in each individual display to illustrate the concentrations of repairs.

13. The method of claim 12 wherein step (c) further comprises operating the electronic processing system to generate an a color gradient scale in each of the individual visual displays to provide numerical values associated with each of the colors for the illustrated concentrations of repairs in each of the individual visual displays.
